(19) United States
(12) Patent Application Publication
(10) Pub. No.: US 2010/0049495 A1
(43) Pub. Date: Feb. 25, 2010

(54) METHOD AND APPARATUS FOR THE SIMULTANEOUS MULTI-LEVEL AND/OR MULTI-SIMULATOR DESIGN OPTIMIZATION OF ELECTRONIC CIRCUITS

(76) Inventors: Kenneth Francken, Zonhoven (BE); Martinus Antonius Hendrikus Vogels, Kessel-lo (BE); Jan Maria Jozef Decaluwe, Leuven (BE)

Correspondence Address: BACON & THOMAS, PLLC, 625 SLATERS LANE, FOURTH FLOOR, ALEXANDRIA, VA, 22314-1176, US

(21) Appl. No.: 12/444,091

(22) PCT Filed: Oct. 2, 2007
(86) PCT No.: PCT/EP2007/060488

§ 371 Date: Apr. 2, 2009

(30) Foreign Application Priority Data
Oct. 4, 2006 (GB) 0619537.4

(51) Int. Cl. G06F 17/50

(52) U.S. Cl. 703/14

(57) ABSTRACT

The present invention relates to a system for synthesizing an electronic circuit at plural abstraction levels. The system includes one or more evaluation tools for evaluating the performance and/or behavior of the circuit at the abstraction levels. The system further includes means for passing parameters and/or performances between abstraction levels and/or evaluation tools. The system is adapted for evaluating the performance and/or behavior of the circuit using at least part of the passed parameters and/or performances at a plurality of the abstraction levels within one synthesis iteration.

### FIELD OF THE INVENTION

The invention relates to the field of electronic design automation (EDA) in general and automated electronic circuit design in particular as well as to the manufacture of electronic devices or circuits. In one exemplary aspect, the invention relates to a computer based or computer assisted system and method of electronic design automation (EDA) and in particular automated electronic circuit design. In another exemplary aspect, the invention relates to the design of analog and mixed-signal electronic circuits. In another exemplary aspect the invention relates to apparatus and methods for the design of custom digital electronic circuits. In yet another exemplary aspect, the invention relates to apparatus and methods for the design of printed circuit boards (PCB).

In the following, the term “designer” signifies the user of the methods described in this invention, regardless of any experience or job function such user might have. The present invention comprises improved methods and apparatus for accurately capturing and analyzing and/or solving electronic design problems. In particular, the present invention allows the multilevel and/or multi-simulator analysis and/or sizing or optimization of electronic circuits.

### BACKGROUND OF THE INVENTION

Electronic circuits can be designed in many ways and using a plethora of software tools. The design of analog, mixed-signal and custom digital circuits in general is a complex problem with many design variables (parameters) and performance specifications and complex relations between them. In order to solve such problems optimally, insight into the complex trade-offs that manifest themselves needs to be gained. To design and analyse their circuits, designers make use of simulation software programs (or ‘tools’, hereinafter also referred to as simulators, evaluators or extraction programs). These programs allow to extract, directly and/or indirectly (e.g. by using an extra post-processing step), circuit performances given a description of the circuit topology, including, but not limited to, a netlist (or a schematic which is automatically converted into a netlist) serving as input to the simulator and the values of the design variables.

Design and simulation of electronic circuits can be performed at different levels of abstraction, most notably high-level (sometimes also referred to as behavioral level), describing the functional behavior of a certain block (compound or not) and circuit-level, capturing the behavior of each device or element comprising the complete schematic and taking into account its connections to the other circuit elements. An example of a commercial high-level simulation program is ADVance MS™ from Mentor Graphics® Corporation. Examples of commercial circuit-level simulators are Eldo® from Mentor Graphics® Corporation, Spectre® from Cadence Design Systems, Inc. and HSPICE® from Synopsys, Inc.

Multi-level simulation means that simulations are performed at different abstraction levels. These different simulations can be performed by one and the same simulation package or by different simulation packages. Usually, different descriptions of the circuit are used for different abstraction levels.

The design of electronic circuits is usually performed by (a combination of) hand calculations, simulations, analysis of the circuit performances and adaptation of the design variables. This interactive loop of simulation, analysis and adaptation can be automated and steered by one or more optimization algorithms This method has been readily published in numerous journal and conference papers over many years. A number of free, open-source and commercial implementations are available.

In order to deal with the complexity of practical analog, mixed-signal and custom-digital circuit design, further automation is needed. The main motivations for automation are the achievement of a productivity increase and the increase in circuit performance and robustness. Other advantages are the discovery of solutions that are otherwise hard to find or even impossible to find. Automation can, but not necessarily does, also provide better insight in performance trade-offs. Automation is usually obtained through the (possibly interactive) use of computer software programs. These programs, in order to be effective for analog, mixed-signal and custom-digital design, should incorporate a number of methods and techniques that allow the capturing and solving of these specific design problems. The problem is that prior art, in general, fails to address at least one of the following prerequisites in order to successfully pursue the said motivations and advantages:
provide methods that enable the truthful specification of the design problem (capturing phase)
advance state-of-the-art enough so that circuits of arbitrarily complexity can be designed (execution or solving phase)
provide an intuitive method that facilitates the automated or interactive application of the two aforementioned phases

One particular example of a multi-level simulation system which uses multiple simulators is described in the international patent application entitled “HDL co-simulation in a high-level modeling system” with application number WO 2004/084027 and published on the 30 Sep. 2004. This patent application discloses a system for multi-level design of digital systems which are described in a hardware description language (HDL) and high-level components. The system further provides a specific HDL simulator and a high-level modeling system (HLMS) to achieve a multi-level, multi-simulator modeling system.

The multi-level simulation disclosed in WO 2004/084027 is in practice only a two-level simulation which combines a functional level with a hardware specific level. This hardware specific level is generally limited to basic digital components such as AND, OR or invertor gates or combinations thereof. The functional level specifies desired behavior and triggers events in the hardware level, for instance by generating particular digital inputs to one or more of the hardware components. A drawback of this system is that it is only able to simulate digital circuits and only on two well-defined abstraction levels. The described system is not able to provide information related to other abstraction levels such as the transistor level of the basic digital components and the transistor level of analog circuits including performances related thereto such as gain, bandwidth, dynamic range. Furthermore, the time dependent aspect of the system described in WO 2004/084027 creates a more complex simulation environment that requires adaptations to the evaluation tools themselves.

This and other systems are typically used with a top-down or bottom-up approach for simulations and design. The top-down approach feeds results such as the determined design parameters at a higher abstraction level into a lower abstraction level as performance specifications for the lower level evaluation. However some high-level requirements may be unattainable due to constraints on the lower level which means that the evaluation has to be adapted and restarted at the higher level leading to an expensive (in terms of design time) iteration loop. The bottom-up approach works more or less the opposite way, first a number of low-level possibilities are determined and then those which suit higher level constraints are used at the higher level. However, this is very time consuming and requires a proper a-priori determination of the ranges for the lower level performances. Moreover, lower level sizings may become obsolete when lower level performance constraints (used as design parameters at the higher level) are changed or added.

Another drawback of the system is that each simulator is limited to simulating a specific part of a design and the simulator has to be optimized for all aspects of that part of the design. In other words, the hardware level simulator has to be optimized for speed and efficiency in simulating all the aspects of the hardware level such as inputs and outputs, response times, delays, etc. In addition, the system only works with specific simulators for both abstraction levels, which means that users are bound to those simulators. This means that users who are experienced with other simulators will have to learn these new simulators. This can have a significant impact on their efficiency as designer and may lead to making errors due to the lack of experience with a particular tool.

In the design of analog circuits or circuits with analog components, there are typically much more performances which are important for a simulation than in the digital domain. Each analog circuit has specific performance requirements dependent on the target application. Besides power, speed (delays) and area as in the digital domain, the analog domain also includes performances such as gain, bandwidth, noise, signal swing, dynamic range, etc.

It is an objective of the present invention to provide an electronic circuit synthesizing system that overcomes the above mentioned shortcomings and drawbacks of the prior art systems. More particularly, it is an objective of the present invention to provide an electronic circuit synthesizing system that is able to synthesize analog, digital, custom-digital, mixed-signal and PCB designs at various abstraction levels. It is another object of the present invention to provide such an electronic circuit synthesizing system which is able to combine any evaluation tools such as simulators. It is yet another objective of the present invention to provide an easy to use system for circuit designers.”

### SUMMARY OF THE INVENTION

The above described problems of the prior art solutions are resolved and the objectives of the present invention are realized by a system for synthesizing an electronic circuit at plural abstraction levels comprising one or more evaluation tools for evaluating the performance and/or behavior of the circuit at these abstraction levels, the system further comprising means for passing parameters and/or performances between abstraction levels and/or evaluation tools and the system being adapted for evaluating the performance and/or behavior of the circuit using at least part of the passed parameters and/or performances at a plurality of the abstraction levels within one synthesis iteration.

In the system according to the present invention, a method is provided to support the use of dependent parameters in the evaluation and/or optimization of electronic circuits or devices. Dependent parameters are circuit variables that are calculated depending on one or more other parameters and/or one or more circuit performances that have been extracted prior to the calculation of the dependent parameter (in the evaluation and/or optimization process). As a result this invention can provide, in one embodiment, the accurate and truthful extraction of performances at different abstraction levels. This can, for example, be achieved by performing the extraction of one or more performances at a higher level of abstraction (this level, for instance, being used because the performances cannot be extracted at a lower level or they would take too much time and/or computing resources), using an optional different simulation tool. Such extractions at different abstraction levels can require a different schematic or netlist with different parameters. In such case, these parameters at the higher level could be dependent on one or more parameters and/or performance extractions at the lower level, or vice versa. By using the dependent parameters method of this invention, such relations can be described and used in the evaluation of the relevant circuit performance and during the optimization loop.

In other words, because the system has means for passing parameters and/or performances between abstraction levels, it becomes possible to simulate multiple levels of abstraction in a single synthesis iteration, either sequentially or simultaneously whereby input and results from one level are used entirely or at least partially in a different level. The system is able to retrieve parameters and performances from the different abstraction levels and provide these to the other abstraction levels where needed. The system can use scripts, expressions or other code to describe parameter dependency functions which can then be interpreted to determine how parameters should be exchanged between abstraction levels. Parameter dependencies can for instance be the relation between a particular parameter at one abstraction level and the performance of the circuit at another level or vice versa.

In addition, the system can use multiple evaluation tools to evaluate performance at the abstraction levels. The system can use a single evaluation tool to perform all the evaluations, a tool per abstraction level or multiple tools on a single abstraction level and other tools on other abstraction levels.

Because the system is able to pass parameters between abstraction levels and evaluation tools and start up the corresponding evaluations within a single synthesis iteration, it is possible to acquire information from these multiple abstraction levels to steer the next iteration. This avoids the major shortcomings of the top-down or bottom-up approach. Any results of a particular abstraction level can be returned and used at a different abstraction level. As such there is no need to start the synthesis process all over again or to start the process by generating a large number of possibilities which may or may not be useable at other abstraction levels. Thus, the parameter passing results in a meet-in-the-middle approach.

Optionally the means for passing parameters and/or performances are further adapted for passing additional information between abstraction levels and/or evaluation tools. Further optionally, the additional information comprises control statements.

In addition to passing performances and parameters, the system may further be adapted for passing additional information between abstraction levels. One particular example of additional information are control instructions. These instructions can be generated based to synchronize evaluations or parts of simulations. Another use of control instructions is to increase or reduce accuracy of evaluations. For instance, if an evaluation at a particular abstraction level yields a bad result, it may be desirable to reduce the accuracy of evaluations on other abstraction levels. This way, a designer receives an idea of how the system behaves and performs but faster than when normal or high accuracy is used. Instead of changing the accuracy, the system may also reduce or broaden the scope of some evaluations, for instance frequency ranges can be changed to cover only those where good results can be obtained.

Optionally, the system for synthesizing an electronic circuit according to the present invention further comprises means for defining user-defined values as one or more of the following:
a single value;
an enumerated list of values;
a range of values;
a range of values defined by an upper and lower boundary and a step size; and
a range of values defined by an upper and lower boundary and a number points.

Further optionally, the system for synthesizing an electronic circuit according to the present invention comprises means for automatically generating multiple subtestbenches based on a user-defined testbench comprising said user-defined values for testbench variables.

The present invention provides a method, e.g. a computer based or computer assisted method that uses a computer or computers for carrying out the specified tasks, for the definition of an arbitrary number of testbenches. A testbench is a test set-up to evaluate circuit performance. A testbench is a setup, defined in software (and which can optionally be stored in hardware) that describes all necessary information that is needed for the evaluation of a circuit in software or in hardware.

These testbenches are then used in the evaluation of the electronic circuit and/or in an optimization loop or in an interactive manual design loop. At least two and preferably each testbench can define any number of settings relevant to characteristics of that specific testbench, including, but not limited to, a number of extractions (in one embodiment these could be performances of the circuit, erg. the gain or bandwidth), extra circuit elements (in one embodiment this could be a topological description, e.g. a netlist) needed for evaluating certain extractions, environmental parameters (including, but not limited to temperature and supply voltages), etc. Each of these settings can be assigned a single value or an enumerated list of values or a range of values. The method can also include technology, e.g. software applications to run on a computer or computer system, to automatically generate multiple subtestbenches out of the combination of all values for each setting of a testbench, be it a single value, an enumerated list or a range of values. For each extraction being performed within the testbench, the method can also automatically calculate any mathematical and/or statistical information of the subtestbenches, including, but not limited to the average, spread, minimum and maximum values.

In an optional aspect of the invention, a method is provided to allow the use of any data types for any parameters (circuit or other). In one particular embodiment, this allows to parameterize the model for certain device types, e.g. pre-characterized bipolar transistors, which are chosen from a discrete list of (string) values. These can then be optimized by the said method as well.

The user is able to define the values in the testbench for the environmental parameters such as the above listed temperature or supply voltages, but which can also include other parameters such as load and biasing. The user-defined testbench settings can further include analysis types, stimuli, model files, etc. It should be noted that a testbench in the context of the present invention is considered as a general description of the conditions wherein an electronic circuit design is evaluated yielding a measure of the circuit functionality, behavior and/or performance. A subtestbench is considered as a unique combination of the values defined by a user in the testbench. Of course, if the user enters a single value for each parameter and setting, there is only one subtestbench.

However, because a user has a large range of options on how to enter values for parameters such as environmental parameters and other settings, a testbench can easily contain a large number of possible combinations. A user can define the parameters using a single value for a parameter, an enumerated list of values, a range of values which can be limited to boundaries or which may include a step size or a number of points. The step size specifies the amount used to increase the lower boundary for each combination with other parameter values in a subtestbench. The number of points indicates how many values between the boundaries of the range have to be selected when generating all the available combinations for subtestbenches.

Optionally, the system for synthesizing an electronic circuit according to the present invention further comprises one or more optimization tools for calculating design parameter values for desired performance and/or behavior of the circuit.

The optimizer in the system according to the present invention aims at achieving the desired performance and behavior of the circuit The optimizer may not be able to achieve the desired performance and/or behavior in cases where the desired behavior is impossible with a particular circuit. In such case, the optimizer may be able to approximate the desired behavior as much as possible within the boundaries of the circuit. Alternatively, the optimizer may be able to achieve various results which meet the desired performance and behavior of the circuit.

Optionally, the system for synthesizing an electronic circuit according to the present invention further comprises means for making parameter dependencies and/or performances available to a user-specified script.

In an optional aspect of the invention, a method is provided to allow the usage of scripts, expressions or any other code (e.g. compiled or not) of arbitrarily complexity, further referred to as a script, to be used as a performance to be extracted in a testbench. Any extractions defined in any one testbench can thus not only be extractions supported by the testbench evaluator program (e.g. ‘.EXTRACT’ in Eldo) or a fixed-evaluator associated with the said extraction (and thus overriding the specified evaluator in the testbench), but can also be a script. Such a script can then evaluated by a program as described in [1], for example. It will be appreciated that the scripting support in the method is designed in such a way that each script automatically has disposal of, and can reference, any circuit parameter and other performance extraction, be it a script or resulting from any other evaluation, from the same testbench or from any other (sub)testbench, and can perform any (mathematical) operation on those other performance extractions and/or circuit parameters. It will also be appreciated that such a script could also operate on the output data (e.g. waveforms) of any evaluation used in a particular testbench. One embodiment makes use of an interpreter and an interpretive language for script extraction such as the script extraction interpreter and language called the Python language and interpreter respectively, but it will be appreciated that the method is not limited to any particular script language, interpreter or compiler.

The scripts, expressions or other forms of code are thus able to reference any parameter, performance, waveform or evaluation in a testbench, subtestbench, evaluation tool or abstraction level for evaluation within the script. This means that a script can be designed to process any reference to information in the evaluation tools or testbenches before or after the evaluation tool or testbench is used or executed. The result is that an electronic circuit designer or user of the system is able to define scripts which perform processing of synthesis results during an iteration step. The processed results may then be presented to the designer or user in any form or may be used for other evaluations as parameters or performances or be used in other abstraction levels.

The scripts are generally user-specified which means that a user is able to select which scripts are used during the synthesis. In addition, user-specified scripts also means that users are able to write their own scripts, expressions or code which can be used during the synthesis of an electronic circuit.

Optionally, the system for synthesizing an electronic circuit according to the present invention may be characterized in that the scripting language is at least one of the following:
Perl;
Tcl/Tk;
Python;
Ruby; and
a proprietary scripting language.

In order to increase the advantage of the ability to use scripts during synthesis, the present invention may be adapted to provide the means for using well known scripting languages to the users. Scripting languages such as Perl, Tcl/Tk, Python and Ruby are well known and several of these languages are already widely in use in the EDA community. As such, experienced EDA users can easily create new scripts. Proprietary languages may be based on these well known scripting languages making them easy to learn. A proprietary language has the advantage that the developer or vendor of the system according to the present invention gains more control over the abilities of the scripting language. Thus, the developer is able to add more advanced features to the proprietary scripting language which are absent in the general purpose scripting languages such as Perl or Python.

It should be noted that in addition to the above described scripting languages, it may also be possible to include other programming language code in scripts, or even use programming languages in a similar way as scripts. For instance the system may be able to compile C, C++, C#, Java, or other programming languages and include these binaries in the synthesis process.

Optionally, the system for synthesizing an electronic circuit according to the present invention comprises a configurator for specifying the syntax of one or more of the evaluation tools.

The present invention allows to set-up any external evaluator by configuring, once per evaluator, key syntax properties (i.e. information that is needed to prepare the input sets out of testbench-specific data). This information is stored (on any type of storage device for later retrieval, and in memory on program start-up) in human-readible ASCII text, but could more generally be stored in any form and type of coding (including but not limited to binary encoding). Information that could be configured per evaluator includes, but is not limited to, the command to launch the evaluator program and the procedure to extract the values of any performance extractions requested as input to the evaluator out of the output (possibly a file on a storage device) generated by the evaluator. For some of these properties, so called tokens can be used which are placeholders to be replaced by the input pre-processor or the output post-processor. Also regular expressions can be used for matching expression for in- or output The main advantage of said method is that, besides hard-coding or writing complete parsers for supporting one evaluator at a time, any number of evaluators can quickly be configured to work in the main analysis or optimization loop. Another method is to parse the output waveform data and use scripts or (pre)compiled code or any other code and/or a toolbox of pre-defined functionality to further post-process it.

Further optionally, the system for synthesizing an electronic circuit design according to the present invention further comprises means for converting the syntax of an electronic circuit design for use in other evaluation tools at the same abstraction level thereby making use of the configurator-specified syntax.

In this aspect of the invention, a method and apparatus is disclosed that enables the capturing and evaluation of a circuit, e.g. an electronic circuit or device, its parameters, performance extractions and some or all other aspects needed for the design of electronic circuits at the high level or circuit level, using an evaluator (in any form as described in this patent application) independent approach. The method is based on the one-time configuration of such evaluator and the performance extractions of interest. Known methods support one or more of such evaluators of which the syntax is hardcoded in the computer software program by means of a parser. Since the method of this invention enables the easy addition of different extractors, it greatly simplifies the prerequisites of aspects of this invention. This method also enables the automatic translation of a netlist description from one evaluator syntax to another one.

Another method uses a toolbox of predefined functions/extractions using the scripting support described in this patent application. To this end, a parser is used to read the evaluator output waveforms which are further post-processed using the toolbox and/or custom written scripts.

Typically an evaluation tool has a specific syntax which is used to instruct the evaluation tool and to present results from evaluations. For instance a tool has a specific syntax to define design parameters for a particular component in an electronic design or a syntax to retrieve performances, other information (e.g. about the operating regions of individual devices) or a waveform from an electronic circuit or a part thereof evaluated using that evaluation tool. By adding a configurator to the system of the present invention, it is possible to define the syntax for any existing or new evaluation tool available to a user or designer. As such, the system of the present invention is not limited to a particular evaluation tool or set of evaluation tools.

Configurations for specific evaluation tools may be provided by the evaluation tool vendor, the system for synthesis according to the present invention vendor or a user or electronic circuit designer. The system may also include some default configurations for well-known, widely used evaluation tools which can be changed using the configurator.

Typically the translation between the syntax of different evaluation tools is only done on the same abstraction level. However it may be possible to convert between various levels of abstraction for instance translating a transistor-level representation of a component in a more function representation of that component for higher level evaluations.

Optionally the system for synthesizing an electronic circuit according to the present invention is characterized in that an evaluation tool is one of the following:
a transistor level simulator;
a Verilog simulator;
a VHDL tool;
Matlab.

In this aspect of the invention, a method, e.g. a computer based or computer assisted method, is provided to combine the performance extractions resulting from any number of performance extraction programs (be it a simulation program in one embodiment, a script or computer program in a generic mathematical computer package or in any computer language in other embodiments) into the optimization loop, effectively accounting for each design specification. The extraction programs can be run on one or more computers, e.g. in a computer system, in software or in hardware, or any combination thereof. Advantages are at least one of: 1) designers can pick, for each performance to be extracted, the most performant extraction program of those programs that are at his disposal; 2) the extraction programs can be combined in the case where one such program can not extract all performances required; 3) extraction programs that work at different levels of design abstraction can be arbitrarily combined (even if they each have their own input syntax), effectively enabling multi-level optimization. The method can also be applied outside the optimization loop for the analysis, verification, and interactive design of electronic circuits or devices. Besides the definition of the extraction program on a per-testbench basis, also any corresponding model information (if applicable) needed by the extraction program can be specified as a testbench setting.

These evaluation tools may operate at different functional levels or abstraction levels. For instance a transistor level simulator is able to simulate electronic components such as operational ampifiers at a transistor level which takes into account a large number of design parameters related to the individual transistors in the operational amplifier and which affect the functional level of an operation amplifier. A VHDL tool can be used to evaluate a design or a part thereof in a hardware description language and may be used to evaluate digital components in a mixed-signal electronic circuit. Matlab for instance can be used to perform high level functional evaluations of a design or a part thereof. Matlab may for instance be used to evaluate the performance of a filter at the functional level to determine if a particular filter achieves desired results and matlab may use the evaluated performances of the subblocks at the transistor level for some or all of the parameters at the functional level.

Because the system is able to interact with a large range of evaluation tools and types of evaluation tools, the system allows the user to select the best evaluator for a specific part of the evaluation. For instance a particular transistor level tool can be used to evaluate some parameters or performances at the transistor level such as power consumption and behavior within a frequency range and another transistor level tool can be used to evaluate other parameters or performances at the transistor level such as amplification of an amplifier.

Further optionally, the system for synthesizing an electronic circuit according to the present invention may be characterized in that one or more of the evaluation tools are single-kernel evaluation tools adapted for mixed-level and/or multi-level evaluations of performance and/or behavior.

The present invention further relates to a method for synthesizing an electronic circuit at plural abstraction levels using one or more evaluation tools for evaluating the performance and/or behavior of said circuit at the abstraction levels, the method further comprises the step of passing parameters and/or performances between abstraction levels and/or evaluation tools and the step of evaluating the performance and/or behavior of the circuit using at least part of the passed parameters and/or performances at a plurality of the abstraction levels within one synthesis iteration.

### BRIEF DESCRIPTION OF THE DRAWINGS

FIG. 1 is a graphical presentation of an exemplary analysis and/or sizing (including dashed lines) step for the design of electronic circuits using an embodiment of the method described in this invention.

FIG. 2 is a graphical illustration of the contents of a single testbench of FIG. 1.

FIG. 3 is an illustration of two possible execution flows corresponding to FIG. 1.

FIG. 4 illustrates an alternative graphical illustration of the contents of a single testbench of FIG. 1 and subtestbenches generated therefrom.

FIG. 5 illustrates a multi-testbench, multi-simulator system according to an embodiment of the present invention.

FIG. 6a illustrates a top-down design approach as used in the prior art.

FIG. 6b illustrates the synthesis of one block at one level as used in the top-down approach of the prior art.

FIG. 7 illustrates the meet-in-the-middle design approach as used in one embodiment of the present invention.

### DETAILED DESCRIPTION OF EMBODIMENTS(S)

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. Where the term “comprising” is used in the present description and claims, it does not exclude other elements or steps. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

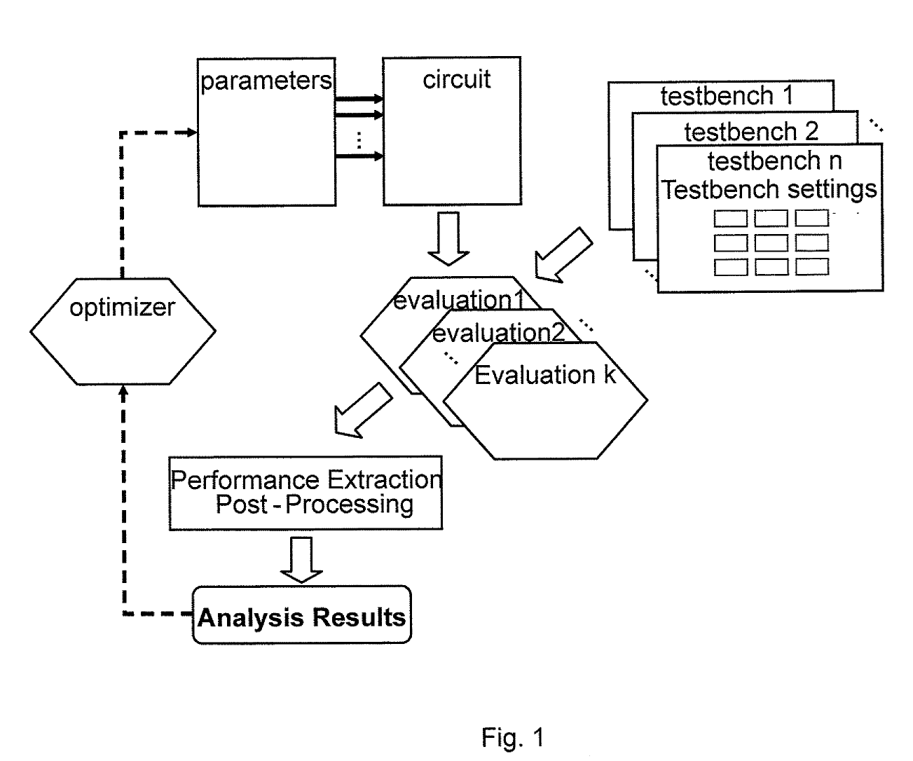

Referring to FIG. 1, according to an embodiment of the present invention, a method, e.g. a computer based or computer assisted method, of defining multiple testbenches allows a designer to accurately capture and analyze a given electronic design problem. The method can equally well be applied to solve electronic design problems by (e.g. interactively) sizing the circuit or optimizing it or migrating it from one process technology to another one and/or to changed performance specifications.

The capturing process is achieved through the setting-up of an arbitrary number of testbenches where each testbench defines all settings that are relevant for extracting any number of related or non-related performances, possibly under certain common conditions. A non-limiting list of examples of such settings are external parameters, such as environmental parameters (e.g. temperature and power supplies, load, etc.), process information (in the case of IC design), analysis type, etc. Process information (or parameters) can encompass the specification of process corners (usually defined in model files supplied by the foundry in the case of a microelectronic process), well known to those of ordinary skills, or customized sets (whereby several process properties for different devices are arbitrarily combined in a custom-defined manner) or process statistics.

Each setting in a testbench can be assigned a single value or an enumerated list of values or a range of values. Said testbench can include any arbitrary number of performance extractions (and corresponding specifications in the form of objectives and/or constraints in the case of sizing or optimization). A testbench might also include extra circuitry, e.g. in the form of a topological description of extra elements and their interconnection (between these extra elements and/or the base circuit) needed to perform the analysis and/or performance extractions.

In case one or more settings in a testbench are assigned an enumerated list (e.g. temperature equals ‘20, 40, 80’ degrees) or a range of values (e.g. temperature ranging from 20 to 80 degrees in steps of 20 degrees), the method of the present invention also includes the automatic generation of all subtestbenches (explicitly or not) whereby each subtestbench has settings with single values and all subtestbenches of a particular testbench cover all the unique combinations over all settings (with single and/or enumerated values and/or values in a range). A simple example clarifies this. Suppose that in one testbench, three supply voltages are defined by means of an enumerated list (1.6, 1.8 and 2.0 Volt) and a range for the ambient temperature is specified (20 to 80 degrees in steps of 20 degrees, thus being equivalent to the enumerated list 20, 40, 60, 80) and two process corners are selected (A and B). One of the aspects of this invention then provides automatic generation of a number of subtestbenches, whereby in this example each subtestbench has the same common properties or settings and only differs in the values of the supply voltage, temperature and process corner triplets. The number of testbenches automatically generated for this example would be 3*4*2=24, and thus the following unique (for each subtestbench) triplets are then generated: (1.6, 20, A); (1.6, 20, B); (1.6, 40, A); (1.6, 40, B); (1.6, 60, A); (1.6, 60, B); (1.6, 80, A); (1.6, 80, B); (1.8, 20, A); (1.8, 20, B); (1.8, 40, A); (1.8, 40, B); (1.8, 60, A); (1.8, 60, B); (1.8, 80, A); (1.8, 80, B); (2.0, 20, A); (2.0, 20, B); (2.0, 40, A); (2.0, 40, B); (2.0, 60, A); (2.0, 60, B); (2.0, 80, A); (2.0, 80, B).

Another aspect of the present invention allows to specify, as one of the settings of a testbench, the evaluator that should be used for the extractions defined in the given testbench. In case the evaluator needs extra information (e.g. device models for integrated circuit design), this information can also be passed on a per testbench basis to the appropriate evaluator. This is achieved through the mechanism explained after first introducing more information about two other aspects of the invention, namely the evaluator independent set-up and extraction definitions and types. It will be of interest, that the described method thus allows to mix any combination of evaluators, possibly from different vendors, possibly at different abstraction levels (and thus enabling true multi-level simulation and optimization), by selecting the proper evaluator on a per testbench basis.

It is clear that this method is not limited to the given example, but can be applied by combining any information that is specified in a testbench. The subtestbenches can be generated on beforehand and stored in computer memory or on any storage device or the subtestbenches can be generated when (and together with) the necessary files and/or commands are generated for submission to the relevant evaluator. The method of automatically generating all subtestbenches greatly simplifies the input and definition of all cases where a given circuit should be evaluated (for analysis or sizing or optimization). Moreover, the method also prevents errors relating to the exact setting up of all testbench settings, such as, in the above example, not specifying one triplet and possibly specifying another one twice.

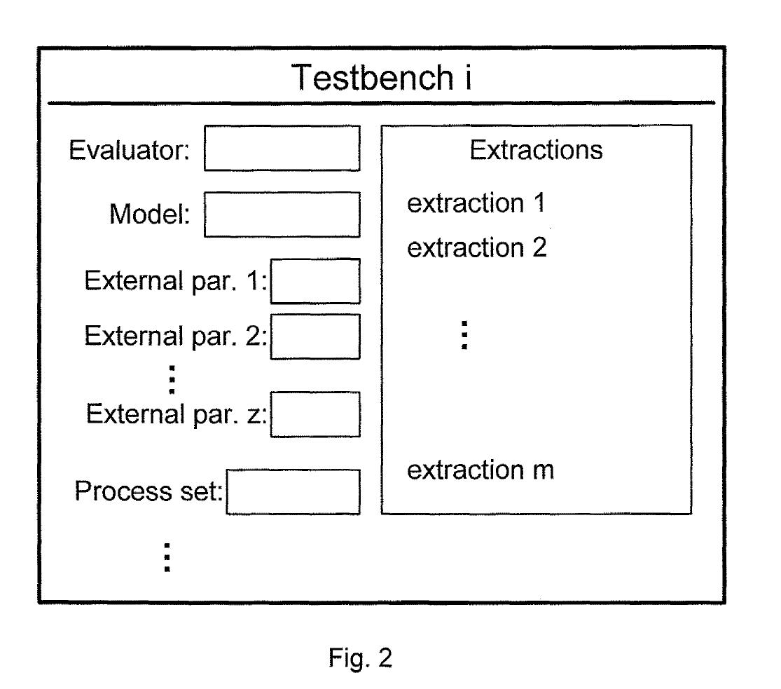

As can be seen in FIG. 2, the described method, in one embodiment, allows to define one or more extractions per testbench. Each of these extractions will be evaluated during the execution of the corresponding testbench or subtestbench and the result will be available to the user, or the optimizer in case of sizing or optimizing an electronic circuit. Some of the extractions might, in one embodiment, be pre-configured as follows. First, a number of extractions (in one embodiment measurements such as gain and bandwidth in the design of electronic circuits, but effectively any other performance extraction) are defined, e.g. by name and unit.

Then, for each evaluator configured (hardcoded or with the method described in a previous paragraph), the extractions of the first step are registered with that evaluator by defining the syntax (or code) that should be given as input to the evaluator for performing such extraction. Said syntax or code can contain any number of parameters (e.g. by means of tokens) whose values are defined when the extraction is instantiated in a testbench. An example of such a performance extraction or measurement could be the gain which could have two parameters, the node in the circuit topology where it is extracted or measured, and the frequency at which it is measured. An extraction defined in the first step can, but does not need to, be associated with a fixed evaluator. In this case, it does not need to be registered with any other evaluator. This can be useful when, e.g., a dedicated evaluator is used for a specific extraction (e.g. an area estimator or a simulator being used for extracting the noise of a circuit). In case such extraction is instantiated in a testbench, the associated evaluator will automatically be used, overriding the testbench evaluator for that particular extraction.

Each extraction defined in a testbench in the present invention can possibly be of a different type, including, but not limited to:
Instantiation of a pre-configured evaluation, passing any necessary parameters (e.g. the node and frequency in case of the gain measurement given as example before). This evaluation might have a fixed evaluator attached to it, overriding the testbench evaluator, in which case the testbench evaluator will still be used for setting up the circuit topology information to be processed by the evaluator. The testbench evaluator might thus be the same or different for any instantiated pre-configured evaluation.
Scripts that perform any form of calculations (including complete computer programs) and which can reference the other performance extractions, from the same testbench or any other, including subtestbenches that are automatically generated, as well as any input parameters. This procedure is explained further on.
   However, other ways (hardcoded or not) than those described above for implementing the input of performance extractions could equally well be used for the present invention.

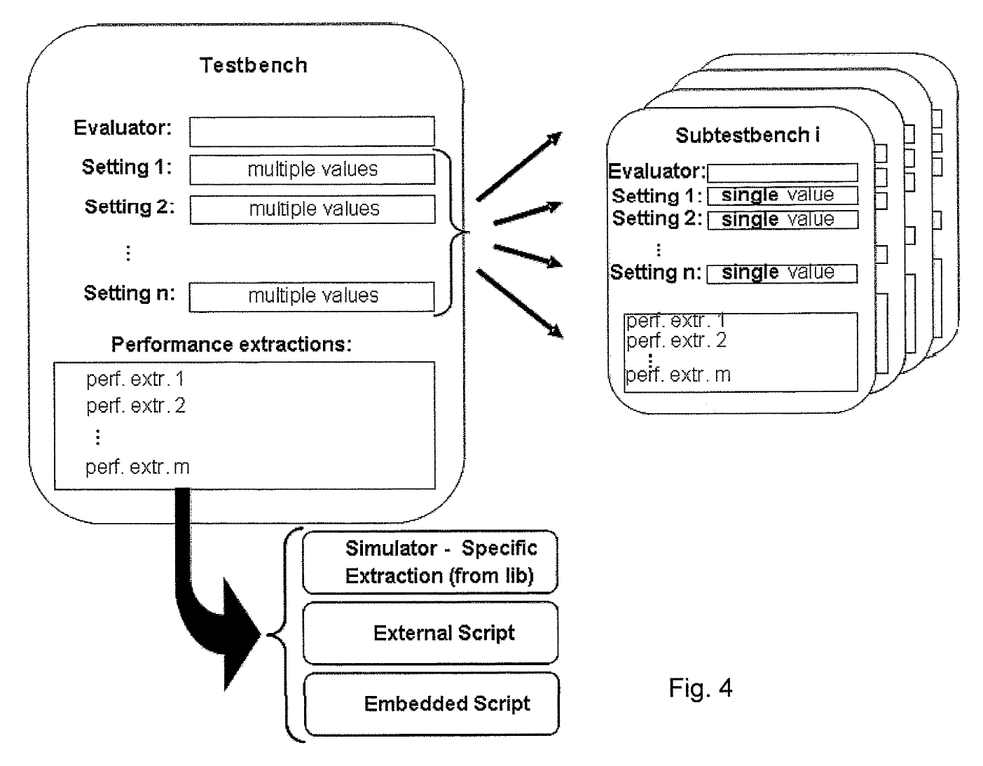

In addition, FIG. 4 illustrates a number of subtestbenches generated based on the information defined in the testbench as illustrated in FIG. 2, and described in the above paragraph. FIG. 4 also shows a number of ways to define different performance extractions.

Although the system allows a user to define extractions for a particular evaluator, it should be noted that not all evaluation tools will support all possible extractions that are of interest to a user or designer. Thus in some embodiments the designer or user has to be aware of the capabilities of the available evaluation tools and take these into account when defining a testbench. In alternative embodiments, the system may be able to detect impossible extractions for a particular evaluator and notify the designer or user thereof.

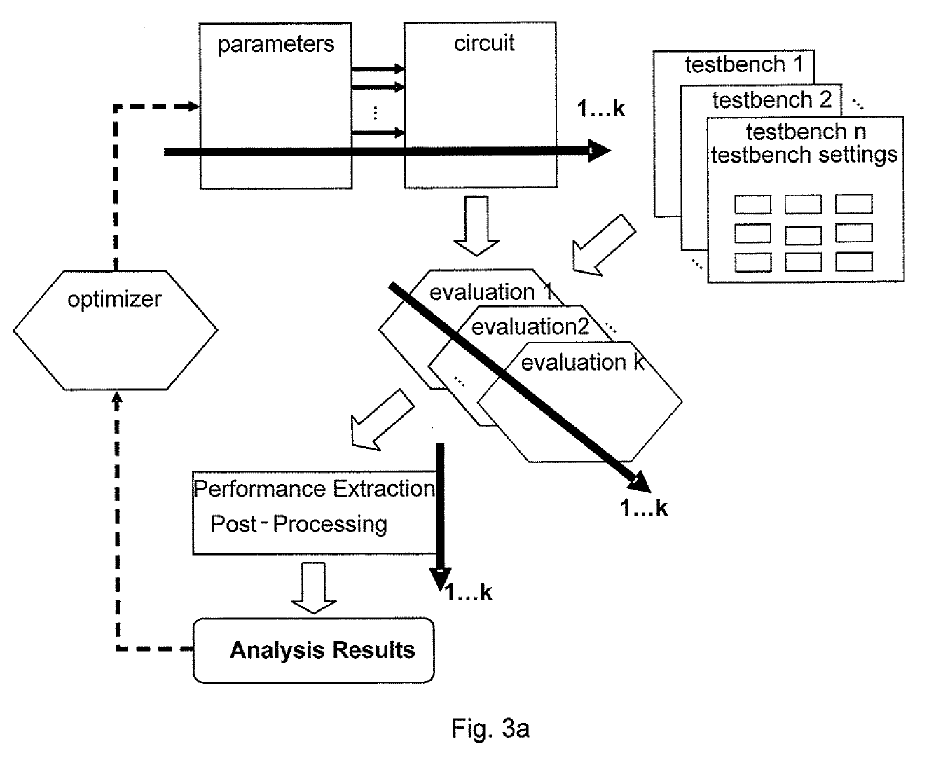

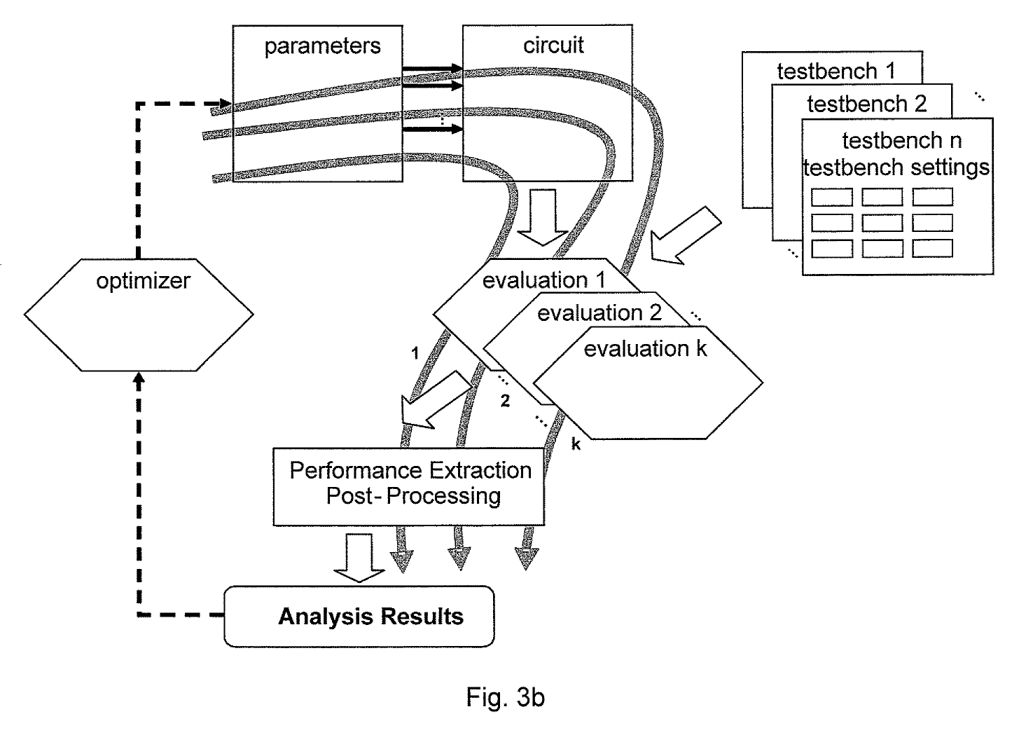

Referring to FIG. 3, it will now be described how one analysis run in FIG. 1 is executed, understanding that such runs can be performed within a loop, e.g. of an optimization, steered by any arbitrary optimization algorithm. For each testbench (or subtestbench) the input data (e.g. in the form of files located on a storage device, but other forms could equally well be used, such as in-memory processing) is first prepared. This step encompasses setting up any necessary information for the evaluator being used, possibly including the topology information (e.g. a netlist) of the basic circuit in the appropriate syntax, additional testbench circuitry, evaluator options, analysis types, model files, process information, external parameter values (such as supply voltages, ambient temperature, component values, etc.) and extractions. All these inputs are supplied to the appropriate evaluators. As illustrated in FIG. 1, the number of evaluations being done is designated by ‘k’. This value can be calculated as follows:

$$k = {\sum }_{i = 1}^{n} {e}_{i}$$

with ‘n’ the number of testbenches and eᵢ the number of evaluations per testbench, namely:

$${e}_{i} = {\sum }_{j = 1}^{m} {b}_{j}$$

with ‘m’ the number of extractions in testbench ‘i’ and bⱼ being zero or one, depending on the fact if the extraction was already taken into account for setting up an evaluation of the same characteristics within the said testbench.

Each of the evaluations can be performed in hardware or in software, on one or more computers, in series or in parallel (though some dependencies could exist in practical design problems where, e.g., a script combines the values of other extractions). Optionally, before actually executing the evaluators, some of the extractions can be combined in one evaluation run of a particular evaluator program. This is, of course, depending on the nature of the extractions and the evaluator being used, but could potentially reduce the number of evaluations (k). In the case of testbench multiplicity (enumerated values or ranges for one or more settings of a particular testbench), all subtestbenches are also automatically generated.

As a final pre-evaluation step, when any scripts are used for one or more extractions to be executed by an embedded interpreter, this interpreter will be initialized and all circuit parameter values (possibly steered by an optimization algorithm in the case of circuit optimization or sizing) will be put in the interpreter's (global) environment. Also, all extractions within each testbench and subtestbench hierarchy are defined and initialized in the interpreter.

Then, all evaluations are carried out by executing the correct evaluators (using their configured commands) and supplying the correct inputs. This step generates a number of outputs (in memory or in files on a storage device) which are then post-processed by the next step.

The third phase encompasses the post-processing of the generated outputs of the evaluators in the execution phase. First, all non-script extractions are retrieved in the main program code. These values (if extracted) are then also made available to the script interpreter (when one or more extractions are scripts). Second, all scripts are being executed in the script interpreter environment. These values are then retrieved in the main program code.

The generation, execution and post-processing of the evaluations can be done consecutively as described above (see FIG. 3a), but can equally well be performed first for the first testbench (or subtestbench), i.e. the generation, execution and post-processing, and then for the second one and so on (see FIG. 3b).

Parameters can be constrained to certain ranges (in the case of optimization) or even disjunct regions in which the design space is searched by the optimizer. Each parameter can also be an independent parameter or a dependent parameter (value), as a function of other parameters and, possibly, performances that have already been extracted. Finally, parameters can be assigned through the execution of scripts and/or compiled code. Because an embedded script interpreter can calculate the dependent parameters on the fly (using the other parameter values and the performance extraction results, see also the flow in FIG. 3b), a very powerful method for multi-level analyis and/or optimization results. Especially when this functionality is used in combination with the per-testbench definition of an evaluator.

In another aspect of the invention, also methods for extending the parameter capabilities (the ‘parameters’ block in FIG. 1) are provided. Parameters can be circuit parameters, or any other parameters. They are allowed to take on discrete or continuous values (e.g. only limited by computer or hardware accuracy, usually, but not necessarily, floating point precision). Examples of device properties that usually can take on continuous values are the width and length of CMOS transistors. For discrete values different representations might be used, such as, but not limited to, integer datatypes, floating point datatype (on a grid, or from enumerated values) and even strings that could be used for indicating a model specified for certain circuit devices. In one embodiment, such discrete values could be used for bipolar transistors that are pre-characterized (e.g. by a foundry) and are only allowed to be assigned one of the devices from the list of pre-characterized devices. It should be noted that the said method is not limited to bipolar transistors, but could be applied to any device type, model or property from, e.g., a netlist. In a final step the designed electronic circuit or device can be reduced to a physical output such as a netlist and/or can be manufactured in accordance with the design produced.

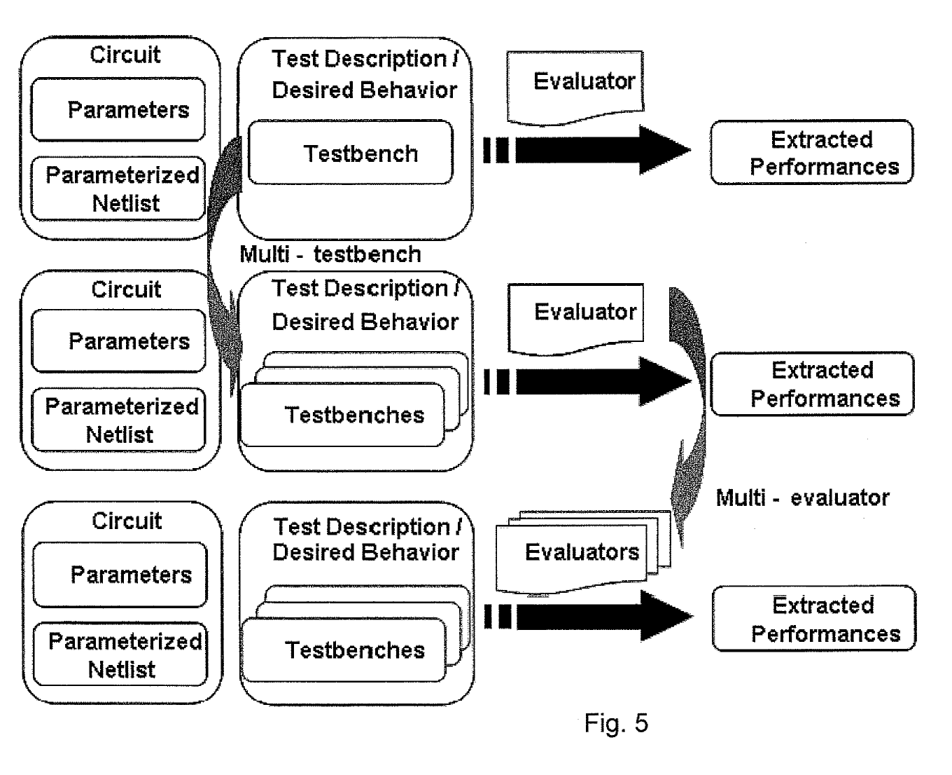

FIG. 5 illustrates three setups of increasing complexity. The first setup shows the process flow from a circuit which is evaluated using a single testbench. This single testbench is then used to drive a single evaluator which provides a set of extracted performances to the user of the system. The second setup shows a similar process flow, however in a multi-testbench situation, for instance a testbench for a particular analysis type and/or a number of parameter combinations. Finally the third setup illustrates a multi-testbench situation where multiple evaluators are used. These evaluators can in one embodiment work at different abstraction levels. The third setup illustrates a more complex and powerful embodiment of the present invention wherein multiple testbenches and multiple evaluators are used.

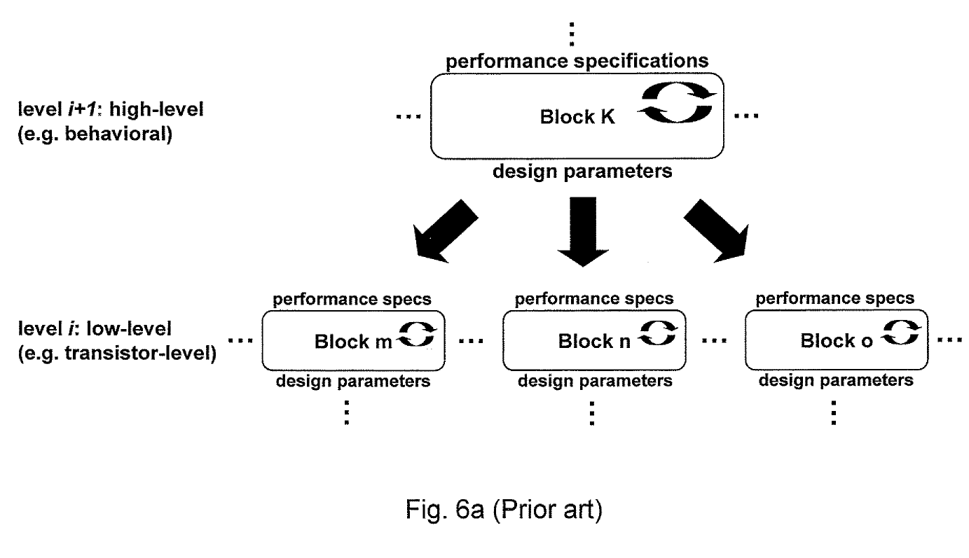

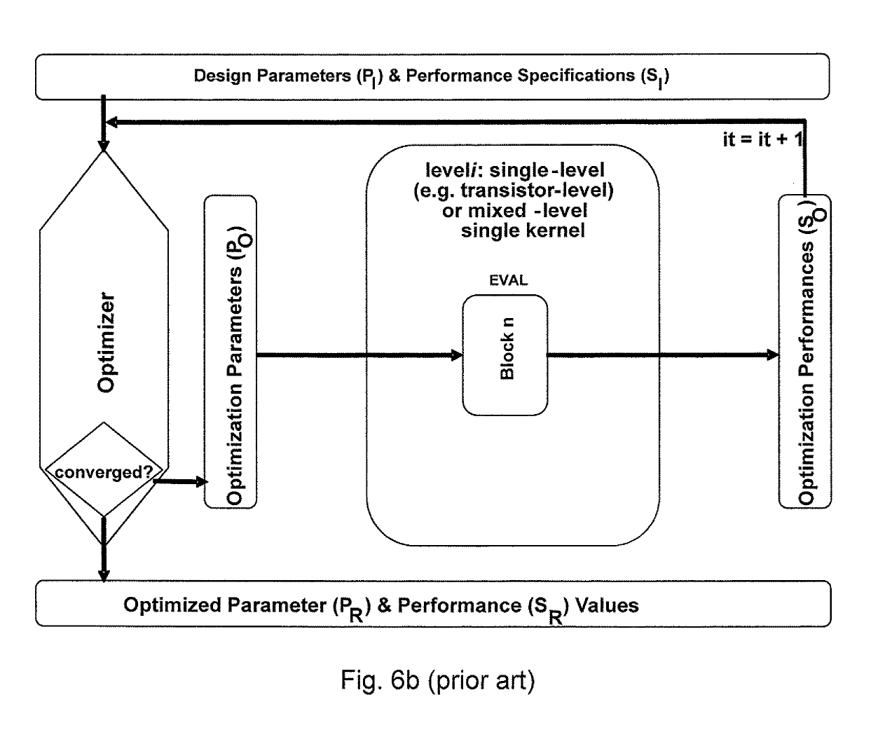

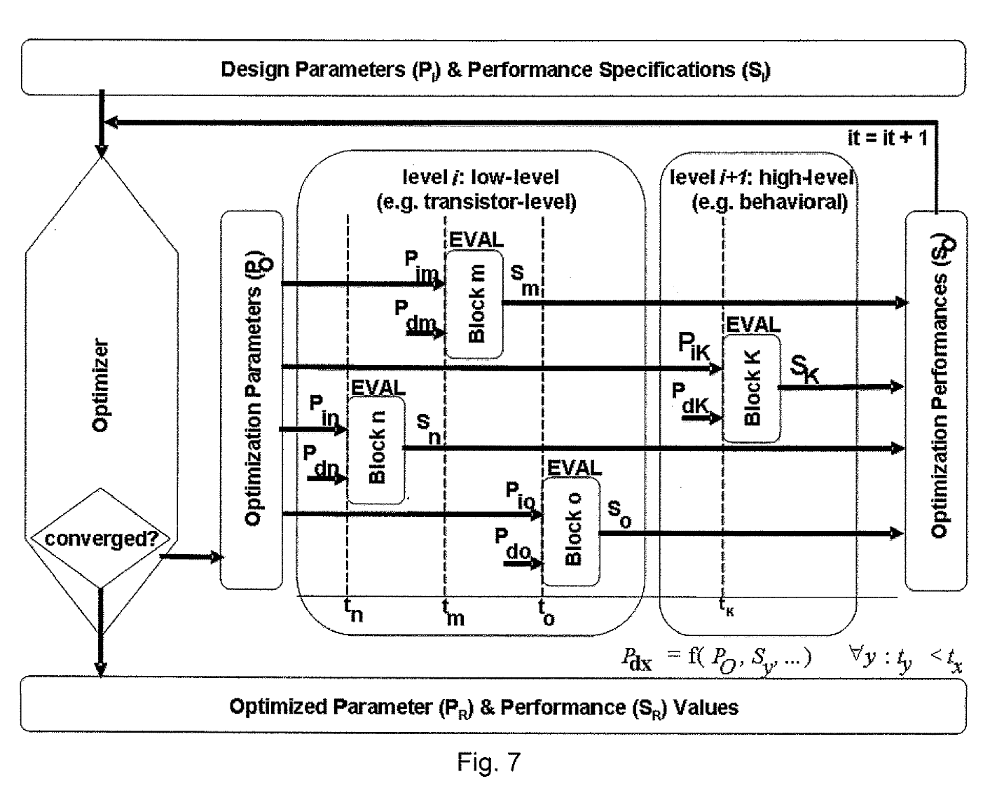

FIG. 6a is an illustration of a typical top-down design flow. FIG. 6b illustrates the synthesis of one block at one level in FIG. 6a as done in prior art. The system according to the present invention allows a new way of multi-level design, in addition to the classical top-down design, where a circuit can be synthesized at plural abstraction levels using one or more evaluation tools and provides means for passing parameters and/or performances between abstraction levels and/or evaluation tools. This approach is called the meet-in-the-middle approach which is illustrated in FIG. 7. The system is adapted for evaluating the performance and/or behavior of the circuit using at least part of the passed parameters and/or performances at a plurality of the abstraction levels within one synthesis iteration.

In FIG. 7, ‘P’ represents one or more parameters and ‘s’ represents one or more performances. The indices to the parameter and performance symbols have the following meaning: ‘I’ for input specification, ‘R’ for results, ‘i’ for independent parameters, ‘d’ for dependent parameters. This clearly shows that within each optimization iteration (it) all levels are evaluated. During each optimization iteration any user-defined dependencies such as parameters dependent on other parameters of the same level (e.g. the drain area of a transistor being dependent on its width and length and the process technology), or parameters dependent on performance evaluations of previously evaluated blocks are taken into account. This can be expressed by the following formula:

P_{dx}=f(P_{O},S_{y}, . . . ), ∀y:t_{y}<tₓ

Wherein P_{dx} represents a dependent parameter that is a design variable for (sub)block x and which is related to or a function of one or more parameters such as P_{O} and performances S_{y} obtained at a time t_{y} which is earlier than time tₓ.

It should be noted that the description of the present invention often refers to a toot, software program or script.

“Said programs can take the form of executable code, code to be interpreted (in one embodiment called a ‘script’) or compiled, in a general-purpose mathematical software language to be executed by such general-purpose mathematical software program (e.g. Matlab® from the MathWorks, Inc.) or a general-purpose computer language (such as C, C++, Fortran, etc.) or script language (such as Perl, Python, Ruby, etc.) to be executed on any hardware device (such as a computer). Said programs can be offered commercially, or be in the public domain, and can be supplied by third-parties or be home-brewn tools or scripts.” [1]

In general, computers or computer systems or computer assisted systems may include one or more processing engines such as microprocessors but such a processing engine may be replaced by any other suitable processing engine, e.g. an FPGA. Hence design systems suitable for use with the present invention can be implemented in digital electronic circuitry, or in computer hardware, firmware, software, or in combinations of them. Furthermore, aspects of the invention can be implemented in a computer program product tangibly embodied in a carrier medium carrying machine-readable code for execution by a programmable processor. Method steps of aspects of the invention may be performed by a programmable processor executing instructions to perform functions of those aspects of the invention, e.g., by operating on input data and generating output data.

Furthermore, aspects of the invention can be implemented in a computer program product tangibly embodied in a carrier medium carrying machine-readable code for execution by a programmable processor. The term “carrier medium” refers to any medium that participates in providing instructions to a processor for execution. Such a medium may take many forms, including but not limited to, non-volatile media, and transmission media. Non-volatile media includes, for example, optical or magnetic disks, such as a storage device which is part of mass storage. Volatile media includes mass storage. Volatile media includes dynamic memory such as RAM. Common forms of computer readable media include, for example a floppy disk, a flexible disk, a hard disk, magnetic tape, or any other magnetic medium, a CD-ROM, any other optical medium, punch cards, paper tapes, any other physical medium with patterns of holes, a RAM, a PROM, an EPROM, a FLASH-EPROM, any other memory chip or cartridge, a carrier wave as described hereafter, or any other medium from which a computer can read. Various forms of computer readable media may be involved in carrying one or more sequences of one or more instructions to a processor for execution. For example, the instructions may initially be carried on a magnetic disk of a remote computer. The remote computer can load the instructions into its dynamic memory and send the instructions over a telephone line using a modem. A modem local to the computer system can receive the data on the telephone line and use an infrared transmitter to convert the data to an infrared signal. An infrared detector coupled to a bus can receive the data carried in the infrared signal and place the data on the bus. The bus carries data to main memory, from which a processor retrieves and executes the instructions. The instructions received by main memory may optionally be stored on a storage device either before or after execution by a processor. The instructions can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

1. A system for synthesizing an electronic circuit at plural abstraction levels comprising one or more evaluation tools for evaluating the performance and/or behavior of said circuit at said abstraction levels; said system further comprising means for passing parameters and/or performances between abstraction levels and/or evaluation tools and said system is adapted for evaluating the performance and/or behavior of said circuit using at least part of said passed parameters and/or performances at a plurality of said abstraction levels within one synthesis iteration.

2. The system for synthesizing an electronic circuit according to claim 1, wherein said means for passing parameters and/or performances are further adapted for passing additional information between abstraction levels and/or evaluation tools.

3. The system for synthesizing an electronic circuit according to claim 2, wherein said additional information comprises control statements.

4. A system for synthesizing an electronic circuit according to claim 1, wherein said system comprises means for defining user-defined values as one or more of the following:
a single value;
an enumerated list of values; - a range of values;
a range of values defined by an upper and lower boundary and a step size; and
a range of values defined by an upper and lower boundary and a number points.

5. The system for synthesizing an electronic circuit according to claim 4, wherein said system further comprises means for automatically generating multiple subtestbenches based on a user-defined testbench comprising said user-defined values for testbench variables.

6. The system for synthesizing an electronic circuit according to claim 1, wherein said system further comprises one or more optimization tools for calculating design parameter values for desired performance and/or behavior of said circuit.

7. The system for synthesizing an electronic circuit according to claim 1 wherein said system further comprises means for making parameter dependencies and/or performances available to a user-specified script.

8. The system for synthesizing an electronic circuit according to claim 5, wherein the language of said script is at least one of the following:
Perl;
Tcl/Tk;
Python;
Ruby; and - a proprietary scripting language.

9. A system for synthesizing an electronic circuit according to claim 1, wherein said system comprises a configurator for specifying the syntax of one or more of said evaluation tools.

10. The system for synthesizing an electronic circuit design according to claim 9, wherein said system further comprises means for converting the syntax of an electronic circuit design for use in other evaluation tools at the same abstraction level thereby making use of the configurator-specified syntax.

11. A system for synthesizing an electronic circuit according to claim 9, wherein said evaluation tool is one of the following:
a transistor level simulator;
a Verilog simulator; - a VHDL tool;
Matlab.

12. A system for synthesizing an electronic circuit according to claim 1, wherein one or more of said evaluation tools are single-kernel evaluation tools adapted for mixed-level and/or multi-level evaluations of said performance and/or behavior.

13. A method for synthesizing an electronic circuit at plural abstraction levels using one or more evaluation tools for evaluating the performance and/or behavior of said circuit at said abstraction levels; wherein said method further comprises the step of passing parameters and/or performances between abstraction levels and/or evaluation tools and the step of evaluating the performance and/or behavior of said circuit using at least part of said passed parameters and/or performances at a plurality of said abstraction levels within one synthesis iteration.
